(19) United States
(12) Patent Application Publication
(10) Pub. No.: US 2003/0167832 A1
(43) Pub. Date: Sep. 11, 2003

(54) Method and apparatus for measuring tire slippage

(75) Inventors: Stanley Jay Novak, Dearborn, MI (US); James Channing O'Connell, Milton Keynes (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Global Technologies, Inc., Dearborn, MI (US)

(21) Appl. No.: 09/683,954

(22) Filed: Mar. 6, 2002

(51) Int. Cl. G01M 17/02

(52) U.S. Cl. 73/146

(57) ABSTRACT

A method and an apparatus 12 for determining the amount of tire slippage occurring on a tire 20 which is mounted upon a wheel 16. The apparatus 12 includes a camera 28 which is mounted within or upon the wheel 16, a controller 26 which is coupled to the camera 28, and a marker arrangement 30 which resides upon the interior surface 32 of the tire 20. As the vehicle 10 is operated, the marker arrangement 30 deflects and an image of such deflection is captured by the camera 28 and communicated to the controller 26, thereby allowing the controller 26 to measure the amount of slippage which is associated with the tire 20.

### BACKGROUND OF INVENTION

1. Field of the Invention.

The present invention generally relates to a method and an apparatus for measuring tire slippage and more particularly, to a method and an apparatus which determines the amount of deflection or movement occurring on at least a portion of the interior surface of a tire, thereby allowing an accurate measurement to be made of the slippage of the tire.

2. Background of the Invention.

A tire does not rotate or turn in an identical manner to the wheel upon which it is mounted due to the characteristics of the tire, the wheel, and/or the vehicle upon which the wheel and the tire are mounted. This difference is often expressed as a slip angle and is usually defined as the angular difference between a first reference point which is located upon the tire and a second reference point which is located upon the wheel, the angular difference being substantially equal to zero when the vehicle is stationary. It is desirable to maintain an appropriate balance or control of the slip angles associated with the front wheels and those associated with the rear wheels in order to reduce the likelihood of understeer and/or oversteer while providing a desired feel to the driver of the vehicle and concomitantly allowing the vehicle to quickly respond to various steering commands.

Large differences between the front and rear slip angles and/or excessively high slip angles may produce undesirable and unusual steering “feel” and handling to the driver and a relatively slow response time (e.g., the time between the initial turning of the steering wheel and the actual turn of the vehicle). Moreover, significantly higher front slip angles may produce undesirable levels of “understeer.” It is therefore typically desirable to have the slip angles of each of front tires be slightly higher than each of the slip angles of the rear tires in order to avoid an over steering condition while allowing for a relatively quick response time and providing a desirable feel to the driver.

Hence, it is desirable to accurately measure the slippage of each of the vehicle”s tires (i.e., the slip angle of each tire) in order to evaluate various tire or chassis designs, to identify potential difficulties, and to ensure that a vehicle performs in a certain desired manner.

While current systems do allow a slip angle to be measured in the laboratory, these systems are complicated and costly. One non-limiting example of such a tire slippage measurement strategy is found within U.S. Pat. No. 5,648,903 which is fully and completely incorporated herein by reference and which measures slip angle by the difference between the tire plane which is perpendicular to the axis of rotation and the tire velocity vector. Moreover, many of these systems are not adapted to allow a slip angle to be measured in an actual vehicular operating condition, thereby further limiting their usefulness to a laboratory type or artificial test environment and thereby providing relatively inaccurate estimates of the slip angles encountered in actual vehicular operating environments. The present invention overcomes these drawbacks in a new and novel manner.

### SUMMARY OF INVENTION

It is a first non-limiting advantage of the present invention to provide a method and an apparatus for measuring tire slippage in a manner which overcomes some or all of the various drawbacks of prior tire slippage measurement systems, strategies, and techniques.

It is a second non-limiting advantage of the present invention to provide a method and an apparatus for measuring tire slippage in a manner which overcomes some or all of the various drawbacks of prior tire slippage measurement systems and strategies and which allows tire slippage to be measured as a vehicle is being driven in an actual vehicular operating environment.

According to a first non-limiting aspect of the present invention, an apparatus for measuring slippage of a tire is provided. The apparatus comprises a first portion which moves in response to the movement of at least a portion of the interior surface of the tire; and a second portion which measures the movement of the first portion, thereby allowing the slippage to be measured.

According to a second non-limiting aspect of the present invention, an apparatus for measuring the slippage of a tire is provided. Particularly, the apparatus comprises a marker which is positioned upon an interior surface of the tire; and a camera which is communicatively coupled to the interior of the tire and which forms an image of the marker.

According to a third non-limiting aspect of the present invention a method for measuring the slippage of a tire is provided. The method comprises the steps of capturing an image of the movement of at least portion of the interior surface of the tire, thereby allowing the slippage to be measured.

These and other features, aspects, and advantages of the present invention will become apparent from a reading of the following detailed description of the invention and by reference to the following drawings.

### BRIEF DESCRIPTION OF DRAWINGS

FIG. 1 is a side view of a vehicle incorporating at least one tire slippage measurement and analysis apparatus which is made in accordance with the teachings of the preferred embodiment of the invention;

FIG. 2 is sectional view of one of the wheels which is shown in FIG. 1;

FIG. 3 is a sectional view of a wheel which is adapted for use in an alternate embodiment of the invention;

FIG. 4 is a side view of a portion of the interior surface of one of the tires which is shown in FIG. 1 when the vehicle is in a stationary state or position; and

FIG. 5 is a view which is similar to that which is shown in FIG. 4 as the vehicle is being driven or is moved.

### DETAILED DESCRIPTION

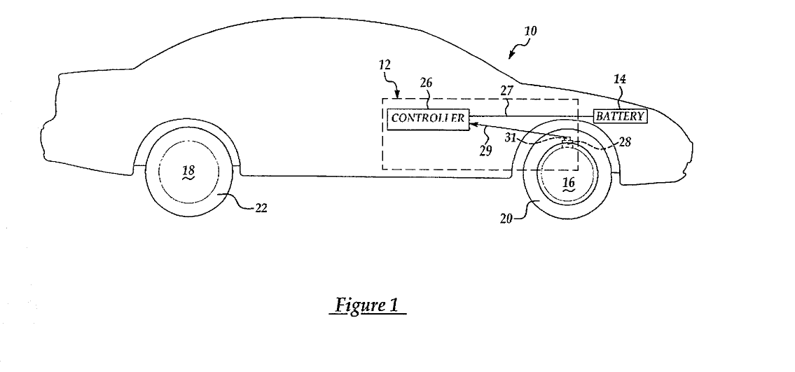

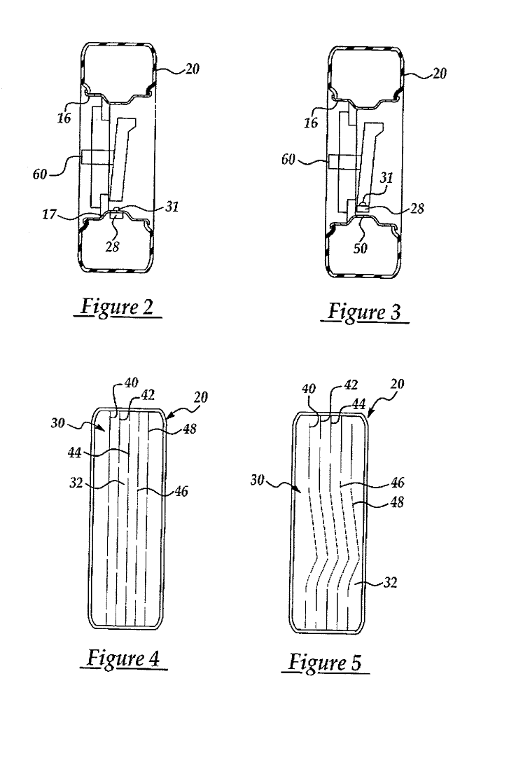

Referring now to FIGS. 1 and 2, there is shown a vehicle 10 having a tire slippage measurement and analysis apparatus 12 which is made in accordance with the teachings of the preferred embodiment of the invention. As shown, vehicle 10 is of the type having a source of electrical energy 14, such as but not limited to a conventional twelve volt electric battery, and at least two wheels 16, 18, which cooperatively allow the vehicle 10 to be selectively maneuvered and which mountingly and respectively receive tires 20,22. It should be appreciated that only the relevant portions of the vehicle 10 are shown and that nothing in this description is meant to limit the applicability of the present invention to a particular type of vehicle or to a particular type of vehicular configuration. For example, the present invention is applicable to a wide variety of vehicles, including but not limited to hybrid electric vehicles and electric vehicles.

Particularly, apparatus 12 includes a controller 26 which operates under stored program control, at least one camera 28 which is communicatively coupled, by the use of electromagnetic or radio frequency energy signal 29, to the controller 26 and which is deployed within and mounted to the interior surface 17 of the wheel 16, and a marker arrangement 30 which is deployed upon the interior surface 32 of the tire 20. Particularly, the camera 28 may be mounted upon the wheel 16 by the use of one or more conventional fasteners such as bolts or screws.

It should be appreciated that each tire, such as but not limited to tires 20, 22, upon the vehicle 10 may have a marker arrangement which is substantially identical to the marker arrangement 30 and that each wheel of the vehicle 10, such as but not limited to wheels 16, 18, may also respectively include a camera which is respectively and substantially similar to the camera 28. Hence, while the operation of the apparatus 12 with respect to the wheel 16 and the tire 20 is described below, it should be appreciated that the foregoing description is equally applicable and substantially identical to the other respective wheel and tire combinations of the vehicle 10, such as to the wheel 18 and the tire 22 and that, in this manner, assembly 10 may measure the slip angles of each of the tires which are operatively mounted upon the vehicle 10. Further, controller 26 is coupled to the battery 14 by bus 27 and camera 28 includes a self-contained battery or energy storage assembly 31. In one non-limiting embodiment, camera 28 comprises a charge coupled device or ccd type of camera, having a radio frequency transmitter (not shown), although other types of cameras may be utilized. Controller 26 has, in one non-limiting embodiment, a radio frequency receiver (not shown) which receives the signal 29 which selectively emanates from the radio transmitter portion of the camera 28. Alternatively, in another non-limiting embodiment, the camera 28 acquires and stores image data during vehicular operation and controller 26 is selectively, physically and communicatively coupled to the camera 28 by the use of a hard wired type bus or cable only after the vehicle 10 has stopped moving. In this manner, the image data is communicated to the controller 26 from the camera 28 after the test operation has been completed.

Particularly, as shown best in FIG. 2, in the preferred embodiment of the invention, marker arrangement 30 comprises a series of substantially identical circles or markers 40-48 which circumferentially traverse the interior surface 32 of the tire 20. Each adjacent pair of circles or markers, such as circles 40, 42, has a substantially similar spacing or separation distance. It should be appreciated that the marker arrangement 30 may be adhesively applied to the tire surface 32 or integrally formed within the interior tire surface 32. It should further be appreciated that circles 40-48 may be replaced with other geometric ensignias or figures and that nothing in this description is meant to limit the present invention to a particular type or configuration of a marker arrangement. Further, it should be appreciated that controller 26 may include a display portion which is adapted to display the images which are captured by and received from the camera 28 by the use of the signal 29, thereby allowing an operator to view the acquired raw image data.

As shown best in FIG. 5, as the vehicle is maneuvered along a surface, the circles 40-48 begin to deflect or move due to tire slippage and the amount and type of such deflection or movement is representative of the amount of such tire slippage or the tire slip angle. Particularly, an image of the marker arrangement 30 (e.g., the deflections of the circles 40-48) is captured by the camera 28 and communicated to the controller 26 by the use of signal 29, where the image may be displayed and analyzed. The average amount by which each of the circles 40-48 have moved is proportional to the slip angle of the tire 20 and hence, these images may be used to calculate the slip angle of the tire 20. That is, as the tire-wheel assembly rotates (e.g., as the wheel 16 and the tire 20 rotate) and load is applied to the tire 20, the tire tread and the interior surface 32 of the tire 20 will deflect laterally. The camera 28 rotates with the tire 20 along the 3 axis and acquires the image data. This lateral deflection is not uniform in that the rear part of the tire contact patch (e.g., the part of the tire contacting the road or surface and positioned toward the rear of the vehicle 10) may deflect a greater amount than the front part of the tire contact patch. Measurements of the amount of distortion or deflection of the circumferential lines 40-46 of the tire 20 (and the other tires) will allow an accurate measurement to be made of the slip angle of the tire 20 (and the other tires) in a real vehicular operational environment (e.g., as the vehicle is being driven on a road). Moreover, by viewing the amount of distortion or deflection for each of the tires one may gain knowledge of the relative difference between the respective slip angles of the front and rear tires (e.g., a large amount of distortion evidences a large slip angle), thereby allowing a designer or engineer to ascertain whether the vehicle will suffer from a relatively slow response time and/or has an undesirable steering condition.

It should be appreciated that, in other non-limiting embodiments, additional cameras may be placed upon the wheel 16 (and the other wheels of the vehicle 10) and each of these other utilized cameras may provide an image of a unique portion of the interior surface 32 of the tire 20 or may provide images which partially overlap (e.g., two images may contain data of the same portion of the interior surface 32).

For example and without limitation, three substantially identical cameras may be mounted wheel 16 and each camera may be adapted to form/obtain images from a unique portion of the interior surface 32 of the tire 20 (e.g., each unique portion corresponding to about one third of the total interior tire surface 32). The same camera deployment may be utilized for each of the other tire and wheel combination of the vehicle 10.

It should be further appreciated, that in other non-limiting embodiments, assembly 12 may also include a force sensor 60 which is mounted upon the wheel 16 and which is adapted to sense the amount and distribution of the forces which are applied to the wheel 16 and to communicate this data to the controller 20 by the use of a hardwired bus or by a radio frequency type signal, thereby allowing a force analysis to be made of the wheel 16. In this alternate and non-limiting embodiment of the invention, which is best shown in FIG. 4, at least one camera 28 may also be mounted upon the force sensor 60 and adapted to capture the image of the marker arrangement 30 through the an optically transparent window 50 which is formed in the wheel 16. That is, in this alternate embodiment, a window or cut out portion is formed within the wheel 16 and a transparent plexiglas sheet 50 or a sheet made of another transparent material covers the formed window and is adhered to the wheel 16 by a conventional fastener member, such as one or more screws or bolts, thereby allowing images of the interior tire surface 32 to be captured by the at least one camera 28.

It should be appreciated that the foregoing invention is not limited to the exact construction and method which has been illustrated and discussed above, but that various changes and modifications may be made without departing from the spirit and the scope of the invention as is delineated in the following claims.

1. An apparatus for measuring slippage of a tire, said apparatus comprising a first portion which moves in response to the movement of at least a portion of the interior surface of said tire; and a second portion which measures said movement of said first portion, thereby allowing said slippage to be measured:

2. The apparatus of claim 1 wherein said first portion comprises at least one marker.

3. The apparatus of claim 2 wherein said second portion comprises at least one camera which forms an image of said at least one marker.

4. The apparatus of claim 2 wherein said at least one marker is adhesively applied to said tire.

5. The apparatus of claim 4 wherein said at least one marker circumferentially traverses the interior surface of said tire.

6. The apparatus of claim 5 wherein said at least one marker comprises a circle.

7. The apparatus of claim 5 wherein said at least one marker comprises a pair of substantially identical circles.

8. The apparatus of claim 3 wherein said apparatus further comprises a wheel having a window portion wherein said wheel mountingly receives said tire and said at least one camera and wherein said at least one camera forms said image of said marker through said window portion.

9. The apparatus of claim 8 further comprising a force sensor which is mounted upon said wheel.

10. The apparatus of claim 3 wherein said at least one camera comprises a charge coupled device.

11. An apparatus comprising a marker which is positioned within an interior surface of a tire; and a camera which is communicatively coupled to the interior surface of said tire and which forms an image of said marker.

12. The apparatus of claim 11 wherein said marker is adhesively applied to said tire.

13. The apparatus of claim 12 wherein said marker circumferentially traverses the interior surface of said tire.

14. The apparatus of claim 13 wherein said marker comprises a pair of circles.

15. The apparatus of claim 14 wherein said pair of circles is substantially identical.

16. The apparatus of claim 15 wherein said apparatus further comprises a force sensor which is mounted upon said wheel.

17. The apparatus of claim 16 wherein said camera comprises a charge coupled device.

18. A method for measuring the slippage of a tire, said method comprising the steps capturing an image of the movement of a portion of the interior of said tire, thereby allowing said slippage to be measured.

19. The method of claim 18 wherein said step of capturing an image of said movement of said interior portion of said tire comprises the steps of forming a marker upon said interior surface; providing a camera; and causing said camera to form an image of said marker.

20. The method of claim 19 wherein said marker circumferentially traverses said interior of said tire.
